(19) United States
(12) Patent Application Publication
(10) Pub. No.: US 2024/0126529 A1
(43) Pub. Date: Apr. 18, 2024

(54) HOUSEHOLD APPLIANCES UPDATE MANAGEMENT

(71) Applicant: Haier US Appliance Solutions, Inc., Wilmington, DE (US)

(72) Inventors: Jason Fuchs, Louisville, KY (US); Alexander Mills, Louisville, KY (US); Sunjay Kolakeri, Winter Springs, FL (US); Joni Ford, Louisville, KY (US)

(21) Appl. No.: 17/964,492

(22) Filed: Oct. 12, 2022

(51) Int. Cl. G06F 8/65

(52) U.S. Cl. CPC G06F 8/65; D06F 34/05

(57) ABSTRACT

A method of operating a household appliance includes connecting the household appliance to a remote computing device and determining that an update is available for the household appliance. The method also includes determining an optimal update time, which may be based on a usage history or an operating status. The method further includes providing a notification of the available update for the household appliance at the determined optimal update time.

### FIELD OF THE INVENTION

The present subject matter relates generally to household appliances which can connect to a home network and/or a remote network such as the internet. In particular, the present subject matter relates to systems and methods for managing features such as update availability over a remote connection for a household appliance.

### BACKGROUND OF THE INVENTION

Household appliances are utilized generally for a variety of tasks by a variety of users. For example, a household may include such appliances as laundry appliances, e.g., a washer and/or dryer, kitchen appliances, e.g., a refrigerator, a microwave, and/or a coffee maker, along with room air conditioners and other various appliances.

Some household appliances can also include features for connecting to and communicating over a secure wireless network. Such communication may provide connected features on the household appliances, e.g., where the household appliance communicates with a personal device, smart home systems, and/or a remote computing device such as a cloud server or database. Such communication may also provide the ability to update the household appliances, such as to provide new or improved features and functionality to the household appliances by downloading updated control software or firmware to the connected household appliance from the cloud.

Such updates are not necessarily actually provided or applied to the household appliance when available. For example, some users may find the update process for such household appliances to be burdensome or inconvenient, such as when the user is notified of the update and asked to apply it at a time when the user is actively operating the household appliance or is not in a position to easily access or pay attention to the household appliance. As another example, some connectable household appliances may lack features for easily informing a user of an available update. For example, the household appliance may only include a limited or low-end user interface, such as a seven-segment display, which makes providing detailed information, such as update status, inconvenient on the user interface of the household appliance.

Accordingly, there exists a need for systems and methods which permit identifying available updates for household appliances and informing a user of the same in an easier and more convenient manner.

### BRIEF DESCRIPTION OF THE INVENTION

Aspects and advantages of the invention will be set forth in part in the following description, or may be obvious from the description, or may be learned through practice of the invention.

In accordance with one exemplary embodiment of the present disclosure, a method of operating a household appliance is provided. The method includes connecting the household appliance to a remote computing device and determining that an update is available for the household appliance. The method also includes determining an optimal update time based on a usage history. The method further includes providing a notification of the available update for the household appliance at the determined optimal update time.

In accordance with another exemplary embodiment of the present disclosure, a method of operating a household appliance is provided. The method includes connecting the household appliance to a remote computing device and determining that an update is available for the household appliance. The method also includes determining an optimal update time based on an operating status. The method further includes providing a notification of the available update for the household appliance at the determined optimal update time.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of exemplary laundry appliances in accordance with one or more exemplary embodiments of the present disclosure.

FIG. 2 provides a side cross-sectional view of one of the exemplary laundry appliances of FIG. 1.

FIG. 3 provides a perspective view of the other exemplary laundry appliance of FIG. 1 with portions of a cabinet of the laundry appliance removed to reveal certain components of the laundry appliance.

FIG. 4 provides a front view of an exemplary group of kitchen appliances in accordance with one or more additional exemplary embodiments of the present disclosure.

FIG. 5 provides a schematic side view of the group of kitchen appliances of FIG. 4.

FIG. 6 provides a diagrammatic illustration of a primary household appliance and multiple additional household appliances in accordance with one or more additional exemplary embodiments of the present disclosure.

FIG. 7 provides a diagrammatic illustration of a household appliance in communication with a remote computing device and with a remote user interface device according to one or more exemplary embodiments of the present subject matter.

FIG. 8 provides a flowchart illustrating an example method of operating a household appliance according to one or more example embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise. As used herein, numerical terms such as “first,” “second,” “third,” “primary,” “secondary,” “tertiary,” etc., may be used interchangeably to distinguish one component from another and are not intended to signify location or importance of the individual components.

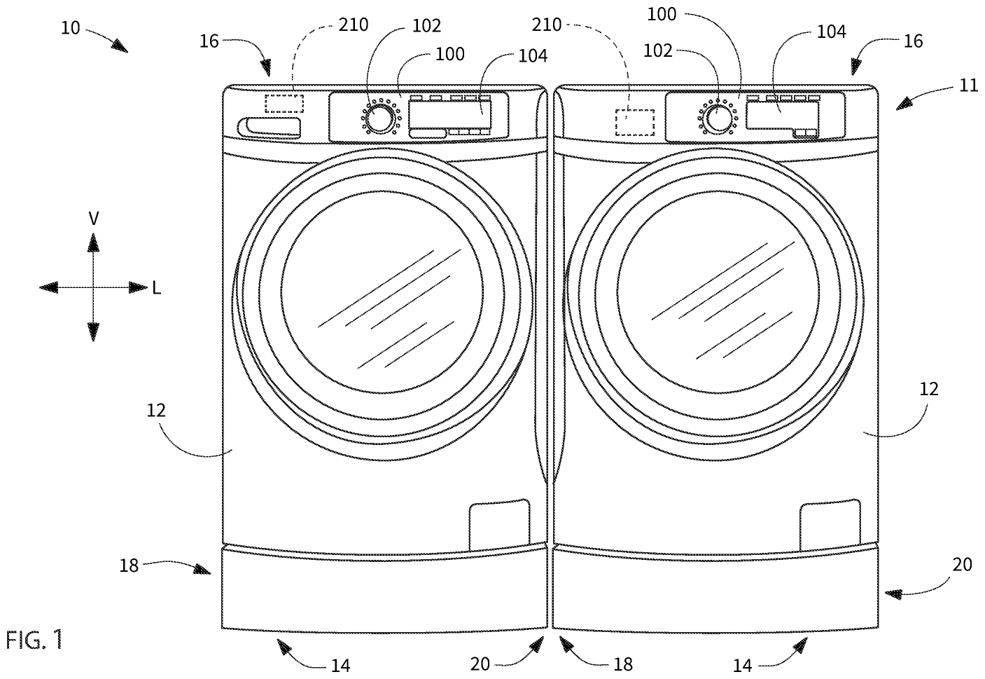

As may be seen in FIGS. 1 through 6, in accordance with one or more embodiments of the present subject matter, a household appliance 10 or 11 is provided, and the household appliance 10 or 11 may be one of a group of household appliances, e.g., a pair or a group of three or more. Each household appliance disclosed herein may be operable and configured to connect to one or more remote computing devices, e.g., over the internet and/or in a cloud, fog, edge, or other distributed computing environment, as will be described in more detail below.

As generally seen throughout FIGS. 1 through 5, the household appliance 10 or 11 includes a cabinet 12 which defines a vertical direction V and a lateral direction L that are mutually perpendicular. Each cabinet 12 extends between a top side 16 and a bottom side 14 along the vertical direction V. Each cabinet 12 also extends between a left side 18 and a right side 20, e.g., along the lateral direction L.

The household appliance 10 or 11 may include a user interface panel 100 and a user input device 102 which may be positioned on an exterior of the cabinet 12. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be the user input device 102.

Generally, the household appliance 10 or 11 may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the household appliance 10 or 11. Operation of the household appliance 10 or 11 may each be regulated by the respective controller 210 that is operatively coupled to the corresponding user interface panel 100. A user interface panel 100 may for example provide selections for user manipulation of the operation of a household appliance, e.g., via user input device 102 and/or display 104. In response to user manipulation of the user interface panel 100 and/or user input device 102, the controller 210 may operate various components of the household appliance 10 or 11. Each controller 210 may include a memory and one or more microprocessors, CPUs or the like, such as general or special purpose microprocessors operable to execute programming instructions or micro-control code associated with operation of the household appliance 10 or 11. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the respective household appliance 10 or 11 by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, the household appliance 10 or 11 may be one of a pair of laundry appliances. In the exemplary embodiment illustrated in FIG. 1, the pair of laundry appliances includes a washing machine appliance 10 and a clothes dryer 11. In embodiments such as illustrated in FIG. 1, the user input device 102 of each household appliance 10 and 11 may be positioned on the user interface panel 100. The embodiment illustrated in FIG. 1 also includes a display 104 on the user interface panel 100 of each household appliance 10 and 11. The display 104 of either laundry appliance 10 or 11 may be a high-end user interface or a component of a high-end user interface, in accordance with the meaning of “high-end” user interface described in more detail below.

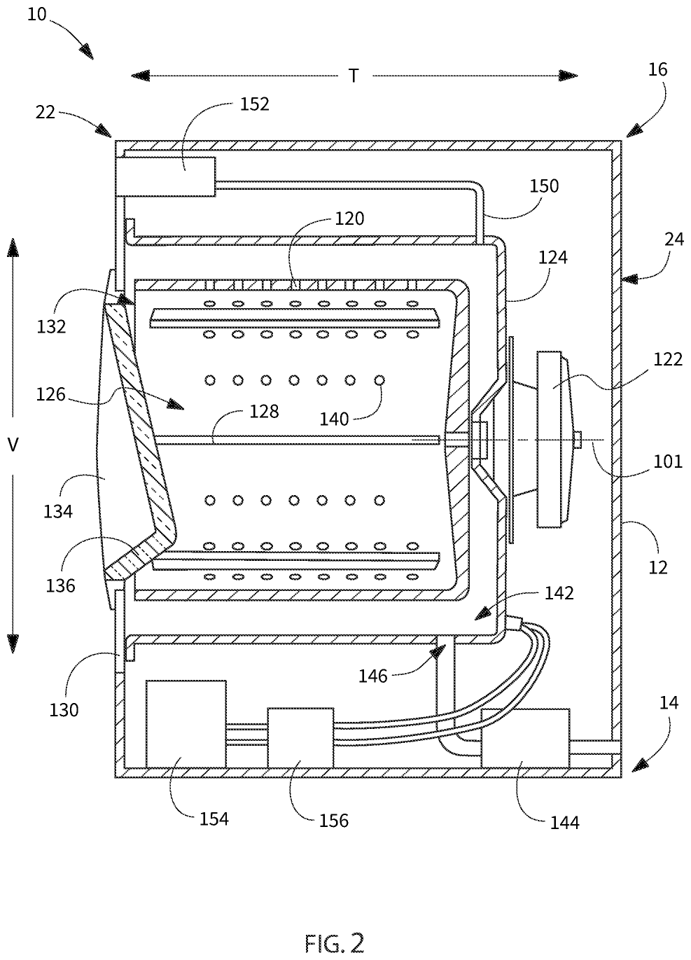

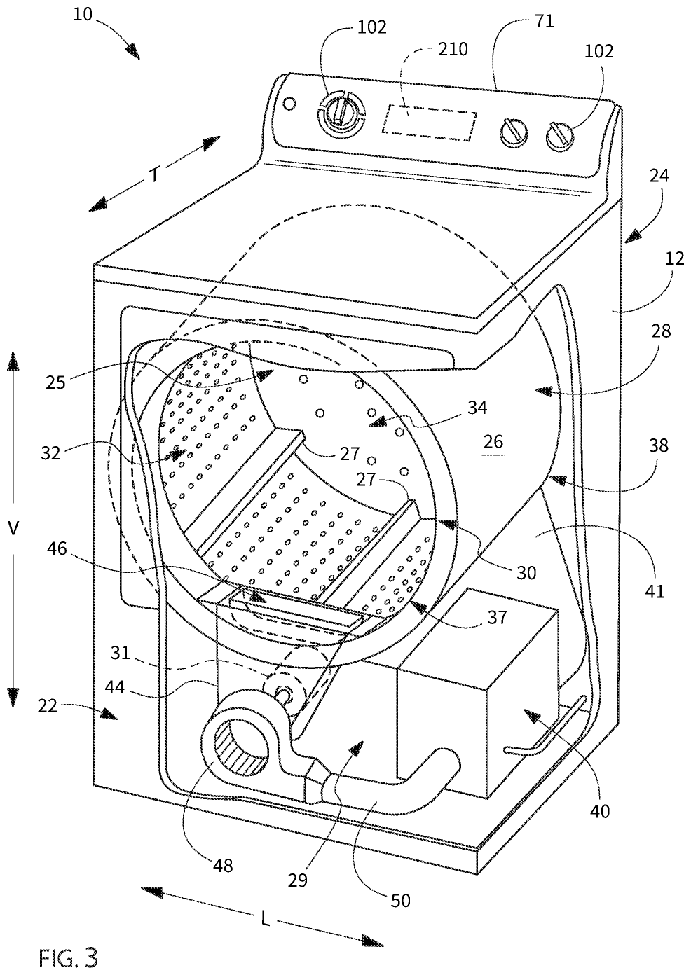

Additional exemplary details of the laundry appliances 10 and 11 are illustrated in FIGS. 2 and 3. For example, FIG. 2 provides a cross-sectional view of an exemplary washing machine appliance 10 which may, in various embodiments, be a connected appliance or one appliance of a group of connected appliances. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of additive, e.g., fluid additive, for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. Other washing machine appliances having different configurations, different appearances, and/or different features may also be utilized with the present subject matter as well, e.g., vertical axis washing machine appliances.

FIG. 3 provides a perspective view of a dryer appliance, such as the dryer appliance of FIG. 1, which is an exemplary embodiment of a household appliance 10. In FIG. 3, the dryer appliance 10 is illustrated with a portion of a cabinet or housing 12 of dryer appliance 10 removed in order to show certain components of dryer appliance 10. Dryer appliance 10 generally defines a vertical direction V, a lateral direction L, and a transverse direction T, each of which is mutually perpendicular, such that an orthogonal coordinate system is defined. While described in the context of a specific embodiment of dryer appliance 10, using the teachings disclosed herein, it will be understood that dryer appliance 10 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” includes but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 10 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 10.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture-laden, heated air is drawn from drum 26 by an air handler, such as blower fan 48, which generates a negative air pressure within drum 26. The moisture-laden heated air passes through a duct 44 enclosing screen filter 46, which traps lint particles. As the air passes from blower fan 48, it enters a duct 50 and then is passed into heating system 40. In some embodiments, the dryer appliance 10 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on a cabinet 12 (e.g., on a backsplash 71) and are in operable communication (e.g., electrically coupled or coupled through a wireless network band) with the processing device or controller 210. Controller 210 may also be provided in operable communication with components of the dryer appliance 10 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, ASICS, or semiconductor devices and is not restricted necessarily to a single element. The controller 210 may be programmed to operate dryer appliance 10 by executing instructions stored in memory (e.g., non-transitory media). The controller 56 may include, or be associated with, one or more memory elements such as RAM, ROM, or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller.

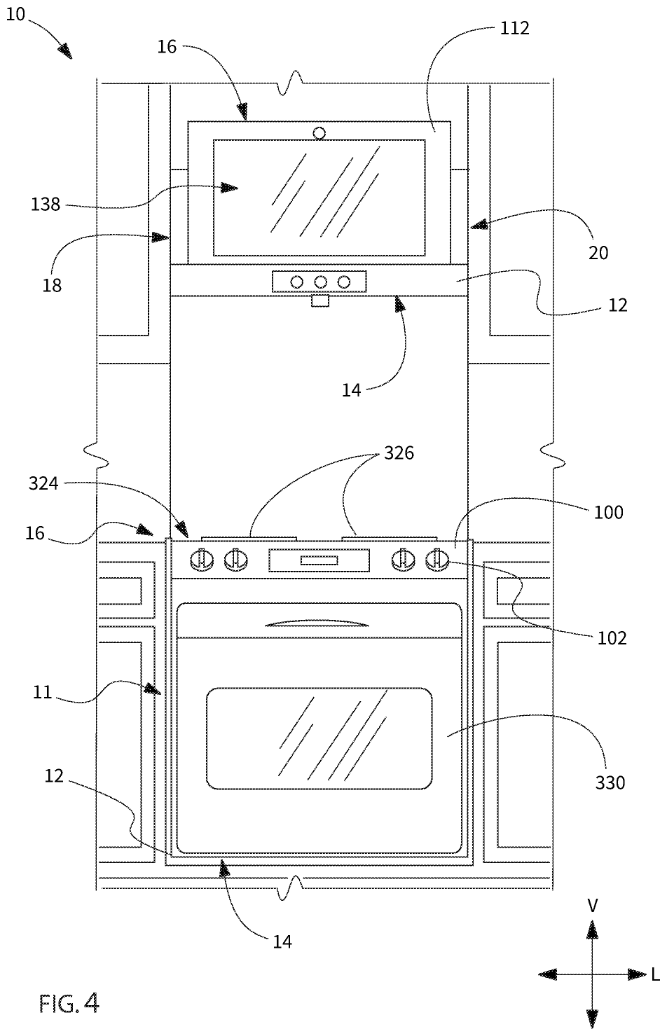

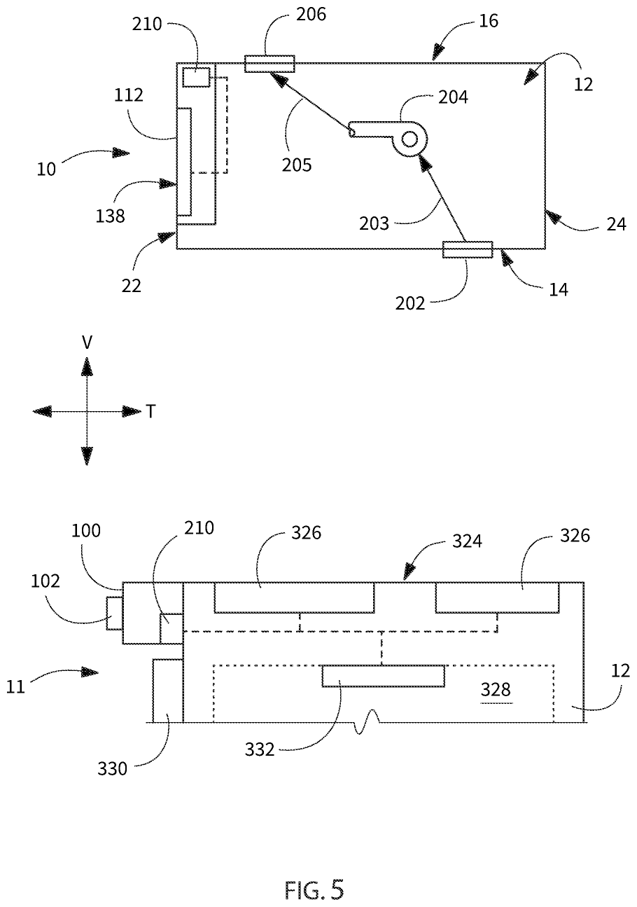

FIGS. 4 and 5 illustrate another example embodiment of a household appliance 10 or 11, each of which is a kitchen appliance. Either of the appliances 10 and 11 in FIGS. 4 and 5 may be operable according to exemplary methods disclosed herein and/or the household appliances 10 and 11 may be a group, e.g., pair, of household appliances in other embodiments of the present disclosure. In the particular exemplary embodiment illustrated in FIGS. 4 and 5, a user engagement system 10 includes an image monitor 112 and is generally positioned above a cooktop appliance 11, e.g., along the vertical direction V. Image monitor 112 may include a touchscreen capable of receiving a user input by detecting and responding to a touch on a surface of the image monitor 112.

Referring again to FIGS. 4 and 5, cooktop appliance 11 includes a chassis or cabinet 12 that extends along the vertical direction V between a top side 16 and a bottom side 14. Cooktop appliance 11 can include a cooktop surface 324 having one or more heating elements 326 for use in, for example, heating or cooking operations. In one example embodiment, cooktop surface 324 is constructed with ceramic glass. In other embodiments, however, cooktop surface 324 may include any another suitable material, such as a metallic material (e.g., steel) or another suitable non-metallic material. Heating elements 326 may be various sizes and may employ any suitable method for heating or cooking an object, such as a cooking utensil (not shown), and its contents. In one embodiment, for example, heating element 326 uses a heat transfer method, such as electric coils or gas burners, to heat the cooking utensil. In another embodiment, however, heating element 326 uses an induction heating method to heat the cooking utensil directly. In various embodiments, the heating elements 326 may include one or more of a gas burner element, resistive heat element, radiant heat element, induction element, or another suitable heating element.

In some embodiments, the cabinet 12 of the cooktop appliance 11 may be insulated and may define a cooking chamber 328 selectively enclosed by a door 330. One or more heating elements 332 (e.g., top broiling elements or bottom baking elements) may be positioned within cabinet 12 of cooktop appliance 11 to heat cooking chamber 328. Heating elements 332 within cooking chamber 328 may be provided as any suitable element for cooking the contents of cooking chamber 328, such as an electric resistive heating element, a gas burner, a microwave element, a halogen element, etc. Thus, cooktop appliance 11 may be referred to as an oven range appliance. As will be understood by those skilled in the art, cooktop appliance 11 is provided by way of example only, and the present subject matter may be used in the context of any suitable cooking appliance, such as a double oven range appliance or a standalone cooktop (e.g., fitted integrally with a surface of a kitchen counter). Thus, the example embodiments illustrated and described are not intended to limit the present subject matter to any particular cooking chamber or heating element configuration, unless explicitly indicated as being limited.

As illustrated, a user interface panel 100 may be provided on cooktop appliance 11. Although shown at front portion of cooktop appliance 11, another suitable location or structure (e.g., a backsplash) for supporting user interface panel 100 may be provided in alternative embodiments. In some embodiments, user interface panel 100 includes input components or controls 102, such as one or more of a variety of electrical, mechanical, or electro-mechanical input devices. Controls 102 may include, for example, rotary dials, knobs, push buttons, and touch pads. A controller 210 is in communication with user interface panel 100 and controls 102 through which a user may select various operational features and modes and monitor progress of cooktop appliance 11. In additional or alternative embodiments, user interface panel 100 includes a display component, such as a digital or analog display in communication with a controller 210 and configured to provide operational feedback to a user. In certain embodiments, user interface panel 100 represents a general purpose I/O (“GPIO”) device or functional block.

As shown, controller 210 is communicatively coupled (i.e., in operative communication) with user interface panel 100 and its controls 102. Controller 210 may also be communicatively coupled with various operational components of cooktop appliance 300 as well, such as heating elements (e.g., 326, 332), sensors, and the like. Input/output (“I/O”) signals may be routed between controller 210 and the various operational components of cooktop appliance 11. Thus, controller 210 can selectively activate and operate these various components. Various components of cooktop appliance 11 are communicatively coupled with controller 210 via one or more communication lines such as, for example, conductive signal lines, shared communication busses, or wireless communications bands.

As shown in FIGS. 4 and 5, the exemplary user engagement system 10, which is an example embodiment of a household appliance, may include one or more casings (e.g., a hood casing) provided above cooktop appliance 11 along the vertical direction V. For example, a hood casing 12 may be positioned above cooktop appliance 11. Hood casing 12 includes a plurality of outer walls and generally extends along the vertical direction V between a top side 16 and a bottom side 14, along the lateral direction L between a right side 18 and a left side 20, e.g., “right” and “left” as used herein refer to from a perspective of a user standing in front of the appliance 10. As shown in FIG. 5, the hood casing 12 may also extend along the transverse direction T between a front end 22 and a back end 24. In some embodiments, hood casing 12 is spaced apart from cooktop surface 324 along the vertical direction V such that an open region is defined therebetween.

As shown in FIG. 5, in kitchen appliance embodiments, the user engagement system 10 may include a ventilation assembly within hood casing 12 which is configured to direct an airflow from the open region between the appliances 10 and 11 and through hood casing 12 of the upper appliance, e.g., which is the user engagement system 10 in the illustrated examples, but which may also be, as another example, an over-the-range microwave oven. Other configurations may be used within the spirit and scope of the present disclosure. For example, although a generally rectangular shape is illustrated, any suitable shape or style may be adapted to form the structure of hood casing 12.

In some embodiments, an image monitor 112 may be provided above cooktop surface 324 (e.g., along the vertical direction V). For instance, image monitor 112 may be mounted to or supported on hood casing 12 of the user engagement system 10 (e.g., directly above cooktop surface 324) proximal to the front side 22. Generally, image monitor 112 may be any suitable type of mechanism for visually presenting a digital (e.g., interactive) image. For example, image monitor 112 may be a liquid crystal display (LCD), a plasma display panel (PDP), a cathode ray tube (CRT) display, etc. Thus, image monitor 112 includes an imaging surface 138 (e.g., screen or display panel) at which the digital image is presented or displayed as an optically-viewable picture (e.g., static image or dynamic video) to a user. Optionally, a protective transparent panel (e.g., formed from a transparent glass, plastic, etc.) may be positioned across or over imaging surface 138. In some such embodiments, the protective transparent panel is mounted within or supported on hood casing 12 forward from imaging surface 138 along the transverse direction T.

As an example, image monitor 112 may present recipe information in the form of viewable text or images. As another example, image monitor 112 may present a remotely captured image, such as a live (e.g., real-time) dynamic video stream received from a separate user or device. As yet another example, image monitor 112 may present a graphical user interface (GUI) that allows a user to select or manipulate various operational features of the user engagement system 10 or cooktop appliance 11. During use of such GUI embodiments, a user may engage, select, or adjust the image presented at image monitor 112 through any suitable input, such as gesture controls detected through a camera assembly, voice controls detected through one or more microphones, associated touch panels (e.g., capacitance or resistance touch panel), sensors overlaid across imaging surface 138, or any other suitable input.

As illustrated, the imaging surface 138 is directed toward the area forward from the cooktop appliance 11. During use, a user standing in front of cooktop appliance 11 may thus see the optically-viewable picture (e.g., recipe, dynamic video stream, graphical user interface, etc.) displayed at the imaging surface 138.

As mentioned, in some embodiments the user engagement system 10 may include a ventilation assembly. In such embodiments, one or more air outlets 206 may be defined by hood casing 12 (e.g., through one or more external walls of hood casing 12). As shown for example in FIG. 5, air outlet 206 defined through hood casing 12 may be defined through hood casing 12 at the top side 16. The ventilation system may generally extend between one or more air inlets 202 defined in the bottom side 14 of the casing 12 and air outlet 206. For example, the bottom side 14 of the casing 12 of the user engagement system 10 may face the cooktop surface 324 of the cooktop appliance 11. The ventilation system may also include an air handler 204 fixedly mounted within the casing 12 in fluid communication with the air inlet 202 to motivate an intake flow of air 203 through the inlet 202 to the air handler 204 and an exhaust flow of air 205 from the air handler 204 to the outlet 206.

As will be understood, air handler 204 may be provided as any suitable blower or fan (e.g., radial fan, tangential fan, etc.) positioned within hood casing 12 to actively rotate or motivate air, steam, or vapors 203 into and through air inlet 202. Optionally, one or more filters (not pictured) may be provided at inlet 202 to clean the air, steam, or vapors 203 as it enters hood casing 12 from the open region between the kitchen appliances 10 and 11. For instance, a grease filter having a suitable coarse filter medium, such as a metallic mesh including aluminum or stainless steel, may be mounted across inlet 202. Additionally or alternatively, an odor filter having a suitable fine filter medium, such as a mesh or block including activated carbon, may be mounted across inlet 202. Optionally, the odor filter may be positioned above or downstream from the grease filter.

According to various embodiments of the present disclosure, the household appliance 10 or 11 may take the form of any of the examples described above, or may be any other household appliance. Thus, it will be understood that the present subject matter is not limited to any particular household appliance.

It should be understood that “household appliances” and/or “appliances” are used herein to describe appliances typically used or intended for common domestic tasks, such as laundry appliances or kitchen appliances, e.g., as illustrated in FIGS. 1 through 5, or air conditioners, dishwashing appliances, water heaters, etc., and any other household appliance which performs similar functions in addition to network communication and data processing. Thus, devices such as a personal computer, router, and other similar devices whose primary functions are network communication and/or data processing are not considered household appliances as used herein.

As used herein, the term “household” or “residence” includes a domestic structure or dwelling place in which one or more people eat, sleep, and/or spend leisure time. For example, a household (e.g., within which the household appliance is located and used) may be a dormitory, condo unit, apartment unit, townhome, single-family home, or other similar places. In additional embodiments, the household appliance or group of household appliances may also be located and/or used in a commercial setting, such as a commercial kitchen or laundromat. Thus, it should be understood that “household appliances” are used herein to refer to the capabilities and functionalities of the appliances without necessarily limiting the appliances to a household setting.

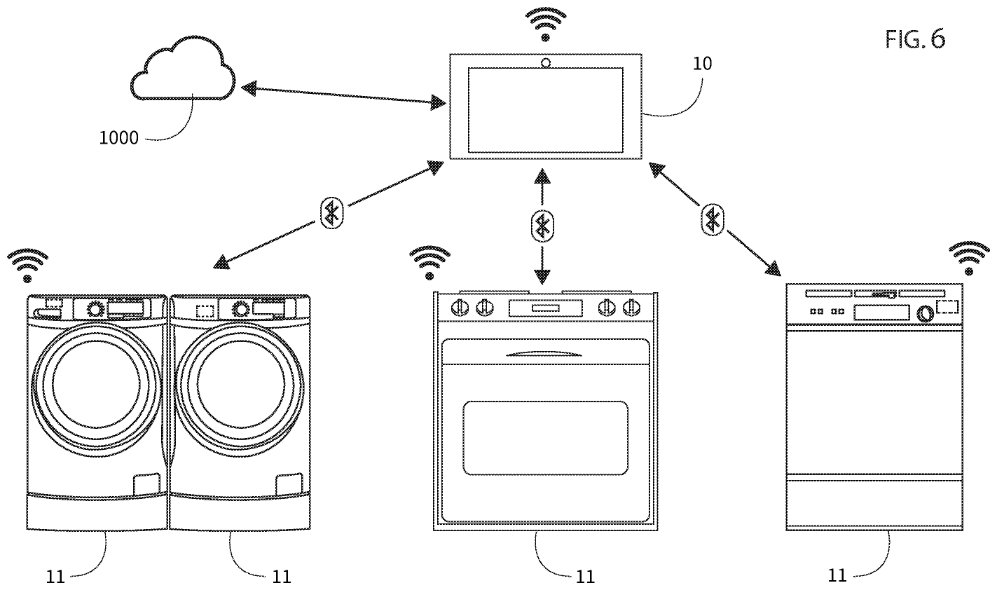

Turning now to FIG. 6 in particular, an exemplary embodiment wherein the household appliance is one of a group of household appliances is illustrated. For example, the group of appliances may include a first or primary household appliance 10 and multiple additional household appliances 11, e.g., multiple second or secondary household appliances 11. In particular, the primary household appliance includes a high-end user interface and is connected to one or more remote computing devices, e.g., a remote server, remote database, and/or one or more other such computing devices, e.g., in the cloud 1000. The terms “second household appliance” and “secondary household appliance” are used herein as including one or more household appliances, such as a second group of household appliances or multiple secondary household appliances, e.g., for which status information, such as connection status, firmware version status, update availability etc., may be displayed on the first or primary household appliance 10.

As used herein, a “high-end user interface” includes any user interface which is context-sensitive and which is capable of displaying a human-comprehensible message, such as multiple lines of text displayed simultaneously. Exemplary high-end user interfaces may also or instead be capable of providing a context-sensitive audio message, such as an audible message including comprehensible language, e.g., spoken words, in contrast to a low-end user interface which may be limited to audible tones, e.g., a beep or chime. A high-end user interface may be or include, but is not necessarily, an interactive display, such as a touchscreen display. A context-sensitive display with one or more soft keys associated with the display may also be considered a high-end user interface even without the ability to receive input directly on the display, e.g., when the display is not a touchscreen. Additionally, a high-end user interface may include an audio input, such as a microphone and an associated controller configured for receiving and interpreting human speech. For example, a high-end user interface may be or include a device capable of sending and receiving audio, e.g., verbal, messages, such as an intelligent virtual assistant. By contrast, a low-end user interface may be a user interface which only includes or is limited to fixed inputs (in contrast to, e.g., context-sensitive soft keys), one or more seven-segment displays, and/or indicator lights (where such indicator lights, e.g., LED indicators, are recognized by those of ordinary skill in the art as only providing binary information, e.g., ON/OFF status indicators only).

FIG. 6 schematically illustrates a primary household appliance 10 in communication, e.g., wireless communication as illustrated in FIG. 6, with one or more remote computing devices in a distributed computing environment, such as a cloud 1000. For example, the primary household appliance 10, and in particular the controller 210 thereof, may be in communication with one or more remote computing devices, such as remote computers, servers, and/or databases, in the cloud 1000. As mentioned above, controller 210 is capable of and may be operable to perform any methods and associated method steps as disclosed herein. Additionally, performance of such methods and method steps may also be distributed, e.g., one or more steps of a method may be performed by the primary household appliance (e.g., controller thereof), while one or more other steps of the same method may be performed by another device, such as a remote computing device (e.g., in the cloud) and/or one or more secondary household appliances.

The primary household appliance 10 may also be in wireless communication with one or more additional, secondary household appliances 11, e.g., via a direct wireless connection and/or with data and other communications relayed between the primary household appliance 10 and the one or more secondary household appliances 11 via a local network, such as a residential wireless network or other wireless local area network (“WLAN”).

The primary household appliance 10 may be in communication with the secondary household appliances 11 through various possible communication connections and interfaces. The primary household appliance 10 and the secondary household appliances 11 may be matched in wireless communication, e.g., connected to the same wireless network. The primary household appliance 10 may communicate with the secondary household appliances 11 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the primary household appliance 10 and the secondary household appliances 11. For example, BLUETOOTH® Low Energy may advantageously minimize the power consumed by the exemplary methods and devices described herein due to the low power networking protocol of BLUETOOTH® Low Energy.

In some embodiments, the performance of exemplary methods and associated method steps may be distributed, e.g., performed in part by the controller 210 of the primary and/or secondary household appliances 10 and 11, and in part by one or more remote computing devices in the cloud 1000. For example, data, which may include identifying information for the household appliances 10 and 11 and version information, e.g., firmware version information, such as a version number or revision date and update availability, etc., may be transmitted from the primary and/or secondary household appliances 10 and 11 to the cloud 1000. The data may be analyzed or processed remotely, e.g., in the cloud 1000, in embodiments which include distributed computing as described above.

As mentioned above, advantages of the present methods include (but are not limited to) a more streamlined and convenient user experience for managing updates to one or more household appliances. For example, the present methods may provide a more convenient way to manage software updates for a household appliance such as downloading, applying, and/or installing the software updates at an optimal time, e.g., a time when the user is paying attention to the household appliance (or another appliance in a common group with the household appliance) and also is not actively using the appliance, e.g., whereby the update may be installed without disrupting the usage of the household appliance, e.g., usage of the household appliance to treat laundry or prepare foods, etc.

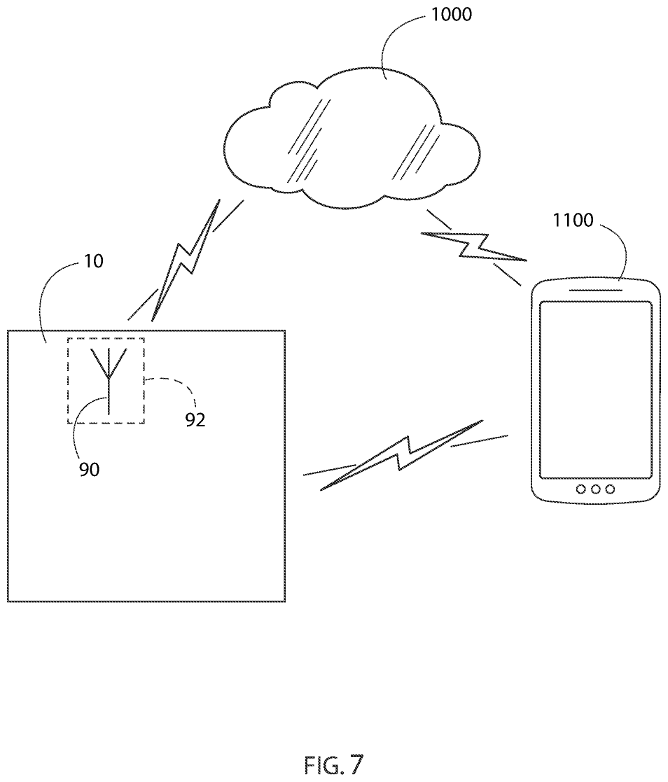

Turning now to FIG. 7, a general schematic is provided of a household appliance 10, which communicates wirelessly with a remote user interface device 1100 and a network 1000, e.g., the cloud or other distributed computing environment such as the fog or the edge. Additionally, the features illustrated in FIG. 7 and described herein with respect to the generic household appliance 10 are equally applicable to any of the exemplary household appliances 11 described above. As illustrated in FIG. 7, the household appliance 10 may include an antenna 90 by which the household appliance 10 communicates with, e.g., sends and receives signals to and from, the remote user interface device 1100. The antenna 90 may be part of, e.g., onboard, a communications module 92. The communications module 92 may be a wireless communications module operable to connect wirelessly, e.g., over the air, to one or more other devices via any suitable wireless communication protocol. For example, the communications module 92 may be a WI-FI® module, a BLUETOOTH® module, or a combination module providing both WI-FI® and BLUETOOTH® connectivity. The communications module 92 may be onboard the controller 210 or may be separate from the controller 210 and coupled to the controller 210, e.g., via a wired connection. The remote user interface device 1100 may be a laptop computer, smartphone, tablet, personal computer, wearable device, smart home system, and/or various other suitable devices.

The household appliance 10 may be in communication with the remote user interface device 1100 through various possible communication connections and interfaces. The household appliance 10 and the remote user interface device 1100 may be matched in wireless communication, e.g., connected to the same wireless network. The household appliance 10 may communicate with the remote user interface device 1100 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the IEEE 802.15.1 standard). In particular, BLUETOOTH® Low Energy, e.g., BLUETOOTH® Version 4.0 or higher, may advantageously provide short-range wireless communication between the household appliance 10 and the remote user interface device 1100. For example, BLUETOOTH® Low Energy may advantageously minimize the power consumed by the exemplary methods and devices described herein due to the low power networking protocol of BLUETOOTH® Low Energy.

The remote user interface device 1100 is “remote” at least in that it is spaced apart from and not physically connected to the household appliance 10, e.g., the remote user interface device 1100 is a separate, stand-alone device from the household appliance 10 which communicates with the household appliance 10 wirelessly. Any suitable device separate from the household appliance 10 that is configured to provide and/or receive communications, information, data, or commands from a user may serve as the remote user interface device 1100, such as a smartphone (e.g., as illustrated in FIG. 7), smart watch, personal computer, smart home system, or other similar device. For example, the remote user interface device 1100 may be a smartphone operable to store and run applications, also known as “apps,” and some or all of the method steps disclosed herein may be performed by a smartphone app.

The remote user interface device 1100 may include a memory for storing and retrieving programming instructions. Thus, the remote user interface device 1100 may provide a remote user interface which may be an additional user interface to the user interface panel 100. For example, the remote user interface device 1100 may be a smartphone operable to store and run applications, also known as “apps,” and the additional user interface may be provided as a smartphone app.

As mentioned above, the household appliance 10 may also be configured to communicate wirelessly with a network 1000. The network 1000 may be, e.g., a cloud-based data storage system including one or more remote computing devices such as remote databases and/or remote servers, which may be collectively referred to as “the cloud.” For example, the household appliance 10 may communicate with the cloud 1000 over the Internet, which the household appliance 10 may access via WI-FI®, such as from a WI-FI® access point in a user's home.

Now that the construction and configuration of household appliance 10 have been presented according to an exemplary embodiment of the present subject matter, exemplary methods for operating a household appliance 10, such as a dryer appliance, oven appliance, or other household appliance, are provided. In this regard, for example, controller 210 may be configured for implementing some or all steps of one or more of the following exemplary methods. However, it should be appreciated that the exemplary methods are discussed herein only to describe exemplary aspects of the present subject matter, and are not intended to be limiting.

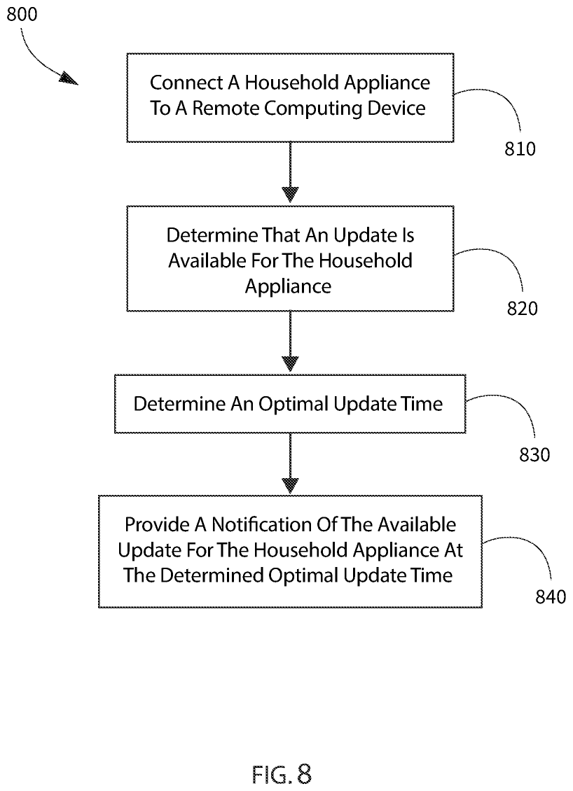

An exemplary method 800 of operating a household appliance is illustrated in FIG. 8. Such methods according to various embodiments of the present disclosure may include connecting the household appliance to a remote computing device, e.g., as indicated at 810 in FIG. 8. Method 800 may further include a step 820 of determining that an update is available for the household appliance, such as an update which may be downloaded from the remote computing device, e.g., the cloud, fog, or edge, to the household appliance.

As shown in FIG. 8, the method 800 may further include a step 830 of determining an optimal update time. The optimal update time may be based on a usage history, and the optimal update time may also or instead be based on an operating status. In various embodiments, the usage history and/or operating status may be of the household appliance, or of another household appliance in the same group as the household appliance, or both. For example, in some embodiments, the household appliance may be one of a group of household appliances and the group of household appliances may include at least one other household appliance. In such embodiments, the operating status on which the determined optimal update time is based may be or include an operating status of the at least one other household appliance, and/or the usage history on which the determined optimal update time is based may be or include a usage history of the at least one other household appliance.

In some embodiments, e.g., where the household appliance is a laundry appliance, e.g., one of a pair of laundry appliances, the optimal update time may be based on the usage history or operating status of the other laundry appliance. For example, when the household appliance is a dryer appliance, the optimal update time may be based at least in part on an operating status of an accompanying washing machine appliance, e.g., the optimal update time may be when the washing machine is not running, such that the user is unlikely to have a need for the dryer appliance in the near future, thereby it may be more convenient for the dryer to be temporarily unavailable while the update is downloaded, applied, and/or installed. In addition, the optimal update time for the dryer appliance may also be determined based on operating status of the dryer appliance itself, such as when the dryer appliance recently completed a dry cycle, or when a current dry cycle is more than halfway complete, e.g., where such operating status indicates the user of the dryer appliance is likely to be attentive to the dryer appliance and is not actively using the dryer appliance, or will soon be done using the dryer appliance. In some embodiments, the optimal update time for the dryer appliance may be based on the operating status of both laundry appliances, e.g., when the washing machine appliance is not actively running a cycle and the dryer appliance recently completed a dry cycle or is close to completing (e.g., more than halfway through) a current dry cycle.

As another example, when the household appliance is a kitchen appliance, such as one of the cooktop 11 and user engagement system 10, the optimal update time for either appliance may be based on the operating status of the other appliance. For example, when the user engagement system 10 is used to display a recipe, the optimal update time for the cooktop appliance 11 or the user engagement system 10 may be near the end of the recipe or just after the recipe is complete, e.g., at such point in time the user is likely to be paying attention to each kitchen appliance and is unlikely to need to continue to operate the kitchen appliances for at least the near term after completing the recipe. Completion of the recipe may be determined based on the operating status of either kitchen appliance, such as an operating status of one or more heating elements and/or a convection fan in the cooktop appliance 11 or an operating status of the display, e.g. image monitor 112, of the user engagement system 10, or an operating status of the ventilation system, e.g., air handler 204, of the user engagement system 10, such as when the air handler 204 turns off may indicate that the user has recently completed cooking.

Some embodiments may also or instead include determining the optimal update time based on a usage history of the household appliance and/or another household appliance from the same group of household appliances as the household appliance. For example, the usage history may include or correspond to one or more periods of time when the household appliance, or group of household appliances, is or are more or less likely to be in use, such that the optimal update time for the household appliance may be, or may be during, one of such time periods with a relatively low (as compared to other time periods in the usage history) probability of the household appliance being activated. In embodiments where the usage history pertains to a group of household appliances, the determined optimal update time may be an optimal update time for each appliance of the group of household appliances. For example, one or both of the laundry appliances may be more frequently used on weekends versus weekdays, such that the optimal update time for the washing machine appliance and/or dryer appliance may be on a weekday. As another example, the kitchen appliances may be more frequently used around meal times, such as during hours of 6:00 AM to 8:00 AM, e.g., around breakfast time, or 4:00 PM to 7:00 PM, e.g., around dinner time, such that the optimal update time for a cooktop appliance, microwave oven appliance, use engagement system, etc. may be in the late morning or at night, e.g., around 10:30 AM or between 10:00 PM and midnight, for example. In some embodiments, the update may be downloaded in response to a user accepting the update, and the installation and application of the update may be scheduled for a later time, such as during a time period from the usage history with a low probability of use, e.g., a weekday in the laundry appliances example or mid-morning in the kitchen appliances example, etc. Such scheduling may be performed automatically, or the scheduled time may be user-selected or user-specified, such as in response to an open-ended prompt for a time or in response to a prompt which includes one or more suggested update times.

In some embodiments, the usage history may include a plurality of time windows and a predicted usage probability for each of the plurality of time windows. For example, the usage history may include a plurality of windows of time in which the appliance is likely to be used, and may include a probability, e.g., percent chance, that the appliance will be in use during each window. Such windows of time and associated probabilities may be developed by tracking over time the usage of the appliance, or each appliance in a group of appliances, such as the days of the week and time of say when the appliance or each appliance is used, e.g., based on start and end times for operating cycles of the appliance(s). For example, the usage history may include twenty four one-hour windows of time for each day, along with a percentage chance that the appliance will be in use during each one-hour span. In some embodiments, the usage history may be captured and stored in a remote computing device, e.g., a remote database, such as a database in the cloud, the fog, and/or the edge.

In various embodiments, the several notifications, prompts, and other information for the user may be provided on the household appliance, e.g., on a user interface and/or display thereof, on a remote user interface device such as a smartphone, tablet computer, etc., on the user interface of another appliance in the same group or location, or combinations thereof. For example, as illustrated in FIG. 6, the notifications, etc. pertaining to updates for any of the secondary household appliances 11, e.g., one or both laundry appliances, a cooktop appliance, a dishwasher appliance, etc., may be provided on the most high-end interface available, e.g., the user interface with a larger number of context-sensitive features and/or wider range of potential inputs as compared to other appliances in the same group or location, such as on the interactive display of the user engagement system in the particular example illustrated at FIG. 6, or by an intelligent virtual assistant, or other high-end user interface, including combinations such as providing notifications, etc. on both the interactive display and as audible, e.g., speech, notifications from the intelligent virtual assistant.

Thus, in embodiments where the household appliance is one of a group of household appliances, the group of household appliances includes at least one other household appliance, and the at least one other household appliance includes a context-sensitive user interface, the notification of the available update for the household appliance may be provided on the context-sensitive user interface of the at least one other household appliance.

Methods and systems according to the present disclosure provide numerous advantages and improvements to technological processes such as updating household appliances to enhance, expand, or otherwise improve the functionality and user experience of such appliances. For example, determining an optimal update time to update a household appliance or to notify a user of the availability of an update may provide an improved user experience and increased adoption rate of updates.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a household appliance, the method comprising:
connecting the household appliance to a remote computing device;
determining that an update is available for the household appliance;
determining an optimal update time based on a usage history; and
providing a notification of the available update for the household appliance at the determined optimal update time.

2. The method of claim 1, wherein the usage history comprises a usage history of the household appliance.

3. The method of claim 1, wherein the household appliance is one of a group of household appliances, the group of household appliances including at least one other household appliance, wherein the usage history comprises a usage history of the at least one other household appliance.

4. The method of claim 1, wherein determining the optimal update time comprises determining the optimal update time based on the usage history and based on an operating status of the household appliance.

5. The method of claim 1, wherein the household appliance is one of a group of household appliances, the group of household appliances including at least one other household appliance, wherein determining the optimal update time comprises determining the optimal update time based on the usage history and based on an operating status of the at least one other household appliance.

6. The method of claim 1, wherein the usage history comprises a plurality of time windows and a predicted usage probability for each of the plurality of time windows.

7. The method of claim 1, further comprising receiving a user-specified time and applying the update at the user-specified time.

8. The method of claim 1, wherein the household appliance comprises a user interface and wherein providing the notification of the available update for the household appliance at the determined optimal update time comprises providing the notification of the available update for the household appliance on the user interface of the household appliance.

9. The method of claim 1, wherein providing the notification of the available update for the household appliance at the determined optimal update time comprises providing the notification on a remote user interface device.

10. The method of claim 1, wherein the household appliance is one of a group of household appliances, the group of household appliances including at least one other household appliance, the at least one other household appliance comprising a context-sensitive user interface, and wherein providing the notification of the available update for the household appliance at the determined optimal update time comprises providing the notification of the available update for the household appliance on the context-sensitive user interface of the at least one other household appliance.

11. A method of operating a household appliance, the method comprising:
connecting the household appliance to a remote computing device;
determining that an update is available for the household appliance;
determining an optimal update time based on an operating status; and
providing a notification of the available update for the household appliance at the determined optimal update time.

12. The method of claim 11, wherein the operating status comprises an operating status of the household appliance.

13. The method of claim 11, wherein the household appliance is one of a group of household appliances, the group of household appliances including at least one other household appliance, wherein the operating status comprises an operating status of the at least one other household appliance.

14. The method of claim 11, wherein determining the optimal update time comprises determining the optimal update time based on the operating status and based on a usage history.

15. The method of claim 14, wherein the usage history comprises a usage history of the household appliance.

16. The method of claim 14, wherein the household appliance is one of a group of household appliances, the group of household appliances including at least one other household appliance, wherein the usage history comprises a usage history of the at least one other household appliance.

17. The method of claim 14, wherein the usage history comprises a plurality of time windows and a predicted usage probability for each of the plurality of time windows.

18. The method of claim 11, wherein the household appliance comprises a user interface and wherein providing the notification of the available update for the household appliance at the determined optimal update time comprises providing the notification of the available update for the household appliance on the user interface of the household appliance.

19. The method of claim 11, wherein providing the notification of the available update for the household appliance at the determined optimal update time comprises providing the notification on a remote user interface device.

20. The method of claim 11, wherein the household appliance is one of a group of household appliances, the group of household appliances including at least one other household appliance, the at least one other household appliance comprising a context-sensitive user interface, and wherein providing the notification of the available update for the household appliance at the determined optimal update time comprises providing the notification of the available update for the household appliance on the context-sensitive user interface of the at least one other household appliance.
